(19) United States
(12) Patent Application Publication
(10) Pub. No.: US 2011/0320119 A1
(43) Pub. Date: Dec. 29, 2011

(54) LOCATION BROKERAGE SYSTEM

(75) Inventors: Henry N. Jerez Morales, Sammamish, WA (US); Matthew Graham Dyor, Bellevue, WA (US); Joe Abou Rjeili, Redmond, WA (US); Rony Ferzli, Redmond, WA (US)

(73) Assignee: Microsoft Corporation, Redmond, WA (US)

(21) Appl. No.: 12/821,264

(22) Filed: Jun. 23, 2010

(51) Int. Cl. G01C 21/00

(52) U.S. Cl. 701/207

(57) ABSTRACT

A location brokerage system is described herein. A plurality of computing devices that are configured to output data that is indicative of a geographic location of a user are registered with the location brokerage system, and a plurality of location-based applications are registered with the location brokerage system. The location brokerage system collaborates with the computing devices to obtain location data pertaining to the user that satisfies requests for location data from the location-based application while enforcing operating restrictions/parameters imposed by the user and/or the location-based applications.

### BACKGROUND

Many different applications currently exist that utilize the location of a user to provide some content or service to the user. Generally, these applications are configured to be installed on portable computing devices such as mobile telephones, wherein the mobile telephones are configured to output data that indicates the location of the mobile telephone. Thus, after installation, a location-based application communicates with one or more sensors on the portable computing device to obtain a current location of the portable computing device.

Example location-based application/services include applications that are configured to provide a user with locations of interest that are proximate to such user, such as restaurants, Automated Teller Machines (ATMs), etc, applications that are configured to provide a user with travel instructions (turn-by-turn navigation) from the current location of the user to an identified end address, applications that are configured to display friends of the user on a map based at least in part upon the location of the user and the locations of the friends of the user, amongst several others. In some of these applications, the user must check in to a particular location to inform his or her friends of his/her current location.

Still other applications include notification applications that can advise the user of a current sale, a warning of an upcoming traffic jam, a weather alert, etc. Applications/services exist that also allow retailers to provide advertisements to an individual based at least in part upon the location of the user. These are just a few of the many different types of location-based applications/services that are currently available for installation on portable computing devices.

Generally, if a user installs multiple location-based applications/services on a portable computing device, each of these applications/services subscribes to a location output by the mobile computing device independently. Moreover, as indicated above, many of these applications are device-specific, since they are configured to receive location data from the device upon which the applications/services are installed.

### SUMMARY

The following is a brief summary of subject matter that is described in greater detail herein. This summary is not intended to be limiting as to the scope of the claims.

Described herein are various technologies pertaining to a location brokerage system that can be configured to manage devices that output data that is indicative of location of a user as well as applications/services that request such data. Pursuant to an example, the location brokerage system can be configured to request or receive location data from a plurality of different devices that are owned and/or operated by a user, and thereafter compute a current location of the user at a certain level of accuracy based at least in part upon data received from the plurality of different devices. Such devices may include, but are not limited to, a portable computing device of the user such as a mobile telephone, a personal computing device of the user, a navigation system in a vehicle operated by the user, amongst other devices that may be owned/operated by the user. The location brokerage system can also be configured to request or receive data from other sensor devices that can provide an indication of a location of the user but which are not owned or operated by the user. These can include, for example, wireless routers that a computing device of the user employs to access a network, public location beacons, card readers that indicate that the user is in a particular store, as well as other suitable sensor devices. The location brokerage system can request location information from particular devices to determine a location of the user at a particular accuracy, can broadcast requests for location information to several devices, or can turn on certain devices to obtain desired location information.

The location brokerage system described herein is also configured to service requests for location data from a variety of location-based applications/services, whether they are executing on a device that belongs to the user or otherwise. Moreover, the location brokerage system can be configured to provide location data pertaining to the user in accordance with certain application-specific and/or user-imposed restrictions. That is, the location brokerage system can allow a user to grant certain applications access to location information with specified accuracy, and can further allow the user to configure the type of information that each application can receive and/or request, and otherwise establish rules and settings for each of the applications. Thus, a user can establish certain rights/restrictions with respect to a particular application receiving data from certain types of sensors that can report the location of the user. Further, the user may specify certain times or refresh periods that the application can request data, and the location brokerage system can enforce these restrictions. Other restrictions are also contemplated.

Since the location brokerage system is configured to service requests for location data from applications in accordance with restrictions imposed upon such applications, the location brokerage system can, in an exemplary embodiment, communicate with a sensor device upon receipt of a request from an application for the location of the user. Thus, for example, an application configured to notify friends of a user when the user reaches a certain geographic location can be provided with rights by the individual to receive location information at a certain level of accuracy from the location brokerage system. The application can request the location of the individual from the location brokerage system, which may in some instances determine that it does not have location data of the appropriate level of accuracy to provide to the requesting application. Consequently, the location brokerage system can communicate with a mobile computing device that is equipped with, for instance, a Global Positioning System (GPS) receiver to determine a more precise location of the individual. That is, the location brokerage system can cause the GPS receiver in the mobile computing device to be activated and obtain a reading, and such reading can be transmitted back to the location brokerage system. The location brokerage system may then format this updated location information to create a data packet that can be accepted by the application and can transmit this data packet to the application responsive to the application requesting the location of the user.

Other aspects will be appreciated upon reading and understanding the attached figures and description.

### BRIEF DESCRIPTION OF THE DRAWINGS

FIG. 1 is an architectural diagram that illustrates operation of a location brokerage system.

FIG. 2 is a functional block diagram of a computing device that comprises a sensor that can output data that is indicative of a geographic location of a user.

FIG. 3 is a functional block diagram of a computing device that is executing a location-based application.

FIG. 4 is a functional block diagram of an exemplary computing device that comprises a location brokerage system.

FIG. 5 illustrates an example application of the location brokerage system.

FIG. 6 is an exemplary graphical user interface that facilitates implementation of user-imposed restrictions on location-based applications and sensor devices.

FIG. 7 is an exemplary graphical user interface that facilitates receipt of user instructions pertaining to location-based applications and restrictions thereon.

FIG. 8 is a flow diagram that illustrates an exemplary methodology for registering an application with a location brokerage system.

FIG. 9 is a flow diagram illustrating an exemplary methodology for servicing a request for location data from a location-based application through utilization of a location brokerage system.

FIG. 10 is a flow diagram that illustrates an exemplary methodology for honoring different requests for location data from different location-based applications that have different restrictions corresponding thereto.

FIG. 11 is an exemplary computing system.

### DETAILED DESCRIPTION

Various technologies pertaining to brokering location data received from sensor devices for selective provision to applications/services requesting the location data will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

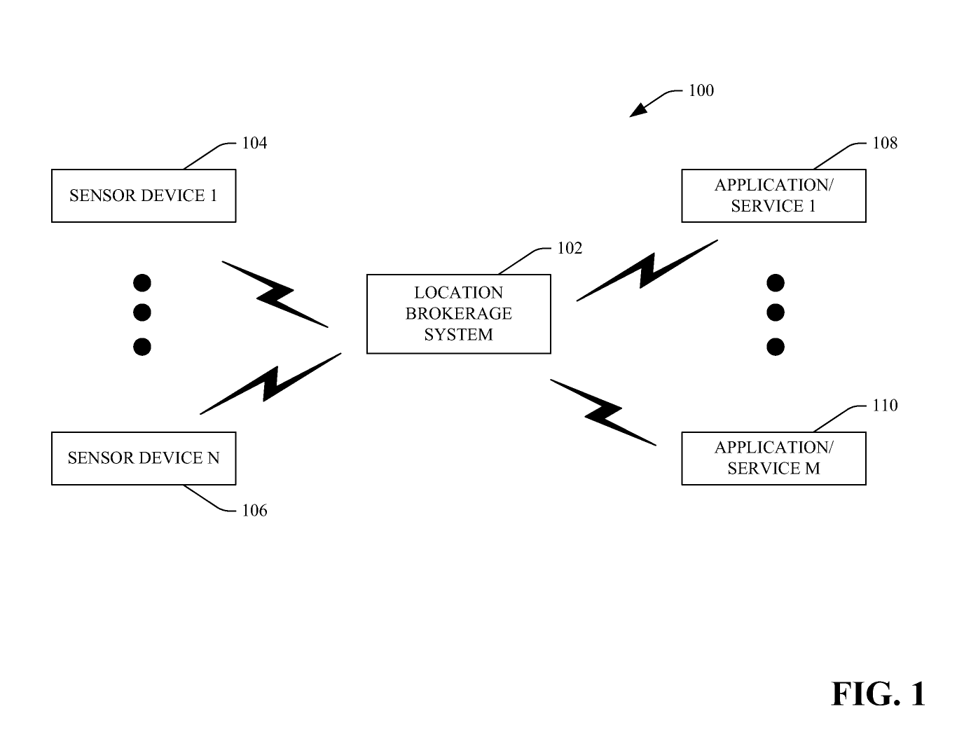

With reference to FIG. 1, an exemplary system 100 that facilitates brokerage of location data to applications/services that are requesting such data is illustrated. The system 100 comprises a location brokerage system (LBS) 102. A plurality of sensor devices 104-106 can be in communication with the LBS 102 by way of any suitable network connection. The LBS 102 may reside on one or more computing devices that are separate from the plurality of sensor devices 104-106 (e.g., the LBS may reside in a cloud computing environment, such that it is distributed across multiple cloud computing devices), or the LBS 102 may reside on a computing device together with at least one of the sensor devices 104-106. Each of the sensor devices 104-106 can be configured to output data that is indicative of a location of a user that may correspond to such sensor devices 104-106. Thus, in an example, one or more of the sensor devices 104-106 can be included in a mobile computing device such as a portable telephone, a personal computing device, a navigation system in an automobile, etc. Further, the sensor devices 104-106 may include a GPS sensor in a mobile telephone, a sensor that is configured to detect location of a device that includes the sensor when the device is communicating through Wi-Fi, Bluetooth, or other suitable wireless communications protocol, etc. In still yet another example, one or more of the sensor devices 104-106 can be configured to detect explicit user action. For instance, a user may utilize an instant messaging application on a computing apparatus that comprises one of the sensor devices, and may indicate that the user is “at work”. The sensor device can analyze this text and output data indicative of the location of the user. In still yet another example, one or more of the sensor devices 104-106 can be configured to monitor a keyboard of a personal computing device to ascertain whether or not a user is utilizing the personal computing device.

In other examples, the sensor devices 104-106 may be included in devices that are not owned or operated by the user. Such devices can include public routers that are utilized to connect computing devices to a network by way of Wi-Fi or other suitable communications protocol, a card reader that reads a credit card or debit card that corresponds to the user that is at a known location, a cellular tower that is communicating or facilitating communications with the user (e.g., by which the user's location can be determined by way of triangulation, and a cellular tower can provide this location information to the LBS 102), a badge reader, an automatic toll machine, etc.

The system 100 further comprises a plurality of computer executable applications/services 108-110, collectively referred to herein as “applications”. Such applications are location-based applications that can receive the location of the user as an input, and provide the user with a service or content based at least in part upon the current location of the user. Example applications that can be included in the applications 108-110 may include, but are not limited to, a mapping application; an application that facilitates presenting the user with locations of certain points of interest proximate to the user, an application that facilitates presenting the user with locations of friends of the user; an application that notifies certain contacts of the user when the user reaches a point of interest or a geographic region of interest; an application that pushes content to the user based at least in part upon the location of the user, amongst other applications. One or more of these applications 108-110 can execute on a computing device that comprises one or more of the sensor devices 104-106. In another example, one or more of the applications 108-110 can reside and be executed on a computing device that comprises the LBS 102. Still further, the applications 108-110 may execute in a cloud computing environment such that a client device utilized by the user is a thin client that interfaces with the cloud computing devices that comprise or execute the applications 108-110.

As will be described in greater detail below, the user can register the applications 108-110 with the LBS 102, and can impose certain operating parameters/restrictions on the applications 108-110. Additionally, the user can cause one or more data packets to be created, wherein the data packet includes policy considerations (e.g., operating parameters/restrictions) with respect to an application, and the application can present such data packet(s) to the LBS 102 for the LBS 102 to evaluate. The data packets can be signed with a suitable digital signature scheme, and can be encrypted utilizing a shared secret key (e.g., a key known by the LBS 102). The LBS 102 may then decrypt the data packet utilizing the shared secret key, and can authenticate the data packet through a suitable digital signature authentication scheme. Of course, other encryption techniques, such as public key/private key techniques, are contemplated. The LBS 102 can retain operating restrictions in a persistent storage resident thereon, and can enforce such restrictions when the applications 108-110 are executing. Restrictions that may be imposed on one or more of the applications 108-110 by the user can include types of devices from which location information is generated that can be utilized by a certain application, restrictions on a current location of the user when a certain application requests the location of the user (e.g., the user may not wish to allow a certain application to know that the user is at home), a time restriction on a certain application such that the application is prohibited from receiving location data pertaining to the user when the user is sleeping, amongst other restrictions. The user can further register additional applications with the LBS 102 or unregister applications from the LBS 102 as desired.

Once the sensor devices 104-106 and the applications 108-110 have been registered with the LBS 102, the LBS 102 can service the applications 108-110 while honoring the operating parameters/restrictions imposed by the user and/or the applications 108-110. For example, during the registration process, when applications 108-110 are registered with the LBS 102, the user can grant the applications 108-110 access to location information provided by one or more specified sensor devices 104-106. The user can also (during the registration process or thereafter) configure a type of information that a particular application can receive and/or request, and can also establish and manage rules and settings for each of the applications 108-110 that are registered with the LBS 102. Such rules generated or provided by the user with respect to the applications 108-110 may pertain to associating certain rights that one or more of the applications 108-110 have with respect to a particular device that comprises one or more of the sensor devices 104-106 and/or a device itself. The user can also establish time restrictions (e.g. a certain application is not allowed to obtain location information of the user after working hours). The user can further restrict one or more applications with respect to a device parameter, such as a restriction on requesting location data from a particular device if battery power is estimated to be below some threshold, etc. Furthermore, at any particular point in time, the user can revoke any rights given to one or more of the applications 108-110.

Once the applications 108-110 and the sensor devices 104-106 have been registered with the LBS 102, the LBS 102 can be configured to transmit updates to one or more of the devices that comprise the sensor devices 104-106, receive location information from one or more of the sensor devices 104-106, request location information from one or more of the sensor devices 104-106, cause one or more of the sensor devices 104-106 to become active, receive requests for location information from one or more of the applications 108-110, provide location data to one or more of the applications 108-110, etc. Additionally, the LBS 102 can be configured to perform processing on data received from one or more of the sensor devices 104-106 to service requests from one or more of the applications 108-110 (e.g., the LBS 102 can generate a location value that is indicative of a location of the user). For instance, an application may wish to know whether or not the user is at home, and the LBS 102 can process data received from one or more of the sensor devices 104-106 to service such request.

Additional detail pertaining to registering the sensor devices 104-106 with the LBS 102 will now be provided. As described previously, the user may own or operate several computing devices that are configured with capability of reporting location information. The user can access or initiate the LBS 102 through any suitable means (e.g., direct a web browser to a web page corresponding to the LBS 102, download the LBS 102 to a personal computing device, etc.). Once the LBS 102 has been accessed, the user may register particular computing devices of such user with the LBS 102. This can be undertaken, in a first example, by way of an automatic discovery process. For instance, a portable telephone may be communicatively coupled to a personal computing device by way of a USB connection or otherwise synched with the personal computing device. The LBS 102 can detect an identity of the personal computing device, and can further detect an identity of one or more computing apparatuses synced with the personal computing device. The list of computing devices that are associated with the personal computing device of the user can then be provided to such user, and the user can select certain computing devices from the list that the user wishes to allow to provide location information. The user may then set parameters as to how often a device may transmit location information, restrictions on transmittal of location information (e.g., restricting the transmittal of location information when battery power of a portable computing device is below a certain threshold, restricting provision of location information when the individual is at certain locations, etc.).

In another example, the user can explicitly identify devices that are owned and operated by the user that can provide location information and can register such devices with the LBS 102. That is, the user can inform the LBS 102 of how to interact with the computing devices, and can further provide restriction with respect to obtaining location information from such computing devices.

As mentioned previously, other types of devices/sensors can also be configured to output data that is indicative of the location of the user. For example, a bank or a card processing service can provide location information pertaining to the user to the LBS 102 when, for example, the user makes a purchase at a shopping center. Furthermore, a computing device can leverage beacons provided by public Wi-Fi access points and either a) compute its own location; or b) provide data to the LBS 102 and the LBS 102 can compute the location of the computing device based upon the provided data. Moreover, other location beacons can be configured to output data that can be received by the LBS 102 in connection with indicating the geographic location of the user. It is to be understood that any suitable device that can uniquely identify the user and provide an indication of a geographic location of the user is contemplated and intended to fall under the scope of the hereto-appended claims. Again, devices not owned and operated by the user can be assigned operating parameters/restrictions by user in connection with providing the location of the user to the LBS 102. That is, the user may have registered several with the LBS 102, and the LBS, and may further impose operating parameters/restrictions on when, where, and how location information is provided to the LBS 102 to indicate the location of the user.

A similar process can be undertaken when one or more of the applications 108-110 are registered with the LBS 102. For example, a user can grant rights to an application, and the application can register with the LBS 102. Alternatively, the user can register the application directly with the LBS 102. The user can specify what type of location information can be requested or used by an application, when the application may request location information, parameters pertaining to restricting requests for location information, etc. Thus, the user maintains control over his location and decides how applications can operate on such data. Applications can also indicate parameters pertaining to how they are to receive data, including formatting instructions, accuracy level at which location information is desirably received, etc.

An example operation of the LBS 102 will now be described. In this example, the LBS 102 can reside in a computing cloud. However, it is to be understood that the LBS 102 may alternatively reside on a personal computing device of the user. The sensor devices 104-106 report location information of the user to the LBS 102 in accordance with parameters/restrictions set forth by the user when the sensor devices 104-106 were registered with the LBS 102. The sensor devices 104-106 may consider other parameters when reporting location information, such as the amount of battery life left in a device that comprises one or more of the sensor devices 104-106, whether the individual is found to be moving or stationery, whether one of the sensor devices is able to contribute to location awareness for the individual, whether another device with better location and/or better performance is available to provide location information, etc.

The LBS 102 can determine a substantially optimal set of sensor devices 104-106 to use in order to compute an indication of location of the user, so long as such substantially optimal set of resources is selected within the restrictions provided by the user. The LBS 102 can centrally determine such substantially optimal set of resources, or alternatively, device-specific agents can reside on computing devices that comprise the sensor devices 104-106. Mixed embodiments, where certain computing devices that comprise the sensor devices 104-106 host such device-specific agents while other devices depend on the LBS 102 operating in a central location are also contemplated. Intermediate, mixed collaborative computations are contemplated as well.

The LBS 102 can receive data packets output from the sensor devices 104-106 and can compute a location value of the user with a certain degree of accuracy (e.g., the LBS 102 can compute an accuracy value). As used herein, “accuracy” can refer to a probability that the user is at a geographic location determined by the LBS 102. In another example, “accuracy” can pertain to a geographic area of the user as determined by the LBS 102. For instance, a first level of accuracy can indicate that the user is at a particular street address, while a second level of accuracy can indicate that the user is within a certain city block. This location information can be retained in a data repository accessible by the LBS 102.

Meanwhile, one or more of the applications 108-110 can subscribe to location-specific information on the LBS 102. The LBS 102 can access the repository that comprises the location information and determine if the location information is at an accuracy that corresponds to the appropriate application. If the accuracy is sufficient, the LBS 102 can provide the location information to the application. Alternatively, the LBS 102 can push location information to a registered application if the LBS 102 is aware that the application wishes to receive such location information.

If the location information retained in the LBS 102 is not sufficiently accurate, then the LBS 102 can cause one or more of the sensor devices 104-106 to provide data to the LBS 102 to allow the LBS 102 to compute the geographic location of the user with the requisite accuracy. In an example, the LBS 102 can generate a general request to appropriate sensor devices 104-106 to report location data back to the LBS 102. In another example, the LBS 102 may transmit a device-specific request to cause a particular device to transmit location information back to the LBS 102. Still further, the LBS 102 can be empowered to cause a sensor device to become active, such that the sensor device transmits location information back to the LBS 102. For instance, the LBS 102 can cause a GPS receiver in a mobile telephone to become activated and transmit a GPS reading back to the location LBS 102. The LBS 102 may then process this location information received from the sensor devices and can report the location to the requesting application at the desired accuracy level and in a format that is acceptable to the requesting application.

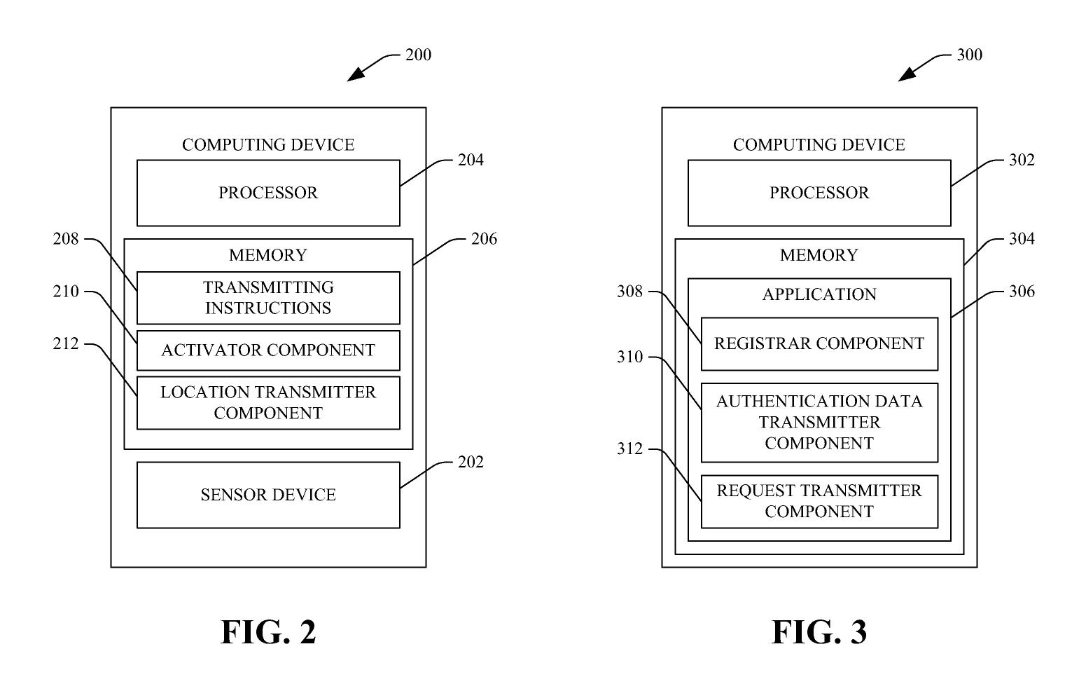

Referring now to FIG. 2, an exemplary computing device 200 that comprises a sensor device 202 that is capable of generating data that is indicative of geographic location of a user is illustrated. The computing device 200 may be any one of the computing devices mentioned above that comprise the sensor devices 104-106 (FIG. 1) or any other suitable computing device. Similarly, the sensor device 202 may be any of the type of sensor devices 104-106 described above or other suitable sensor device. The computing device 200 further comprises a processor 204 and a memory 206 that comprises a plurality of components that can be executed by the processor 204 as well as transmitting instructions 208 that can optionally describe how and when the computing apparatus 200 communicates location information to the LBS 102. The transmitting instructions 208 may be user-defined or may be device-specific. For example, the transmitting instructions 208 can include instructions for periodically transmitting location data to the LBS 102, restrictions on transmitting location to the LBS 102 under certain circumstances, such as when battery power is low, when the user of the computing device 200 is idle, during certain hours (e.g., when the user is sleeping), etc.

An activator component 210 can cause the sensor device 202 to become active and generate data that is indicative of the location of the computing device 200 (and possibly indicative of the location of the user) in accordance with the transmitting instructions 208. Additionally, the activator component 210 can cause a sensor device 202 to become active upon receipt of a request or command from the LBS 102. As described previously, this can occur when an application has requested location information from the LBS 102 and the LBS 102 must obtain location information from the computing device 200 to service such request. Furthermore, the activator component 210 can be a device-specific agent that is configured to activate the sensor device 202 in a manner that provides the LBS 102 with substantially optimal location information given certain contexts.

The memory 206 may also comprise a location transmitter component 212 that can cause data generated by the sensor device 202 to be transmitted to the LBS 102. The location transmitter component 212 can cause this data to be transmitted to conserve battery power, for example. Thus, for instance, the location transmitter component 212 can output data generated by the sensor device 202 in a parasitic manner. For instance, the location transmitter component 212 can cause location data output by the sensor device 202 to be transmitted via a preexisting communications channel and/or can cause the location data to be scheduled with some reporting data, thereby allowing bundling and submitting of relevant data at one time. In an example, instead of establishing an HTTP connection with the LBS 102 in order to transmit location information, the location transmitter component 212 may queue location updates and cause them to be transmitted to the LBS 102 using another communications channel that is already (automatically) established, such as a periodic burst communication. In another example, the communication channel may be established based on user action, such as appended to the payload of another communication, and intercepted by the LBS 102 along a communications path.

Referring now to FIG. 3, an exemplary computing device 300 that executes a location-based application is illustrated. The computing device 300 may be a mobile computing device, a desktop computing device, or other suitable computing device. For example, the computing device 300 may be a cloud-based computing device. The computing device 300 comprises a processor 302, which may be a central processing unit, graphical processing unit, or other suitable processing unit. A memory 304 comprises computer-executable components that can be executed by the processor 302.

Additionally, the memory 304 comprises an application 306, which is a location-based application. The application 306 is configured to receive location of a user as an input, and is configured to provide content or perform some action/service based at least upon the location of the user.

The application 306 may comprise a registrar component 308 that can be used to register the application 306 with the LBS 102. For example, the user of the computing device 300 can download the application 306 to execute on such computing device 300. When the application 306 is installed on the computing device 300, the registrar component 308 can be configured to provide a graphical user interface to the user such that the user can select parameters for receiving/retrieving location information from the LBS 102. Additionally, the registrar component 308 can provide the LBS 102 with information that identifies the application 306, including, for example, some form of key or other type of data that can uniquely identify the application 306 executing on the computing device 300. Again, during the registration process initiated by the registrar component 308, the user can specify sensor devices that may be utilized in connection with providing locations to the application 306, parameters relating to when and where location information may be requested by the application 306, etc. The registrar component 308 can then register the application 306 with the LBS 102. In another exemplary embodiment, the application 306 (and possibly other applications) can have a cloud-based service associated therewith that complements operation of the application 106. The cloud-based service may be configured to operate in conjunction with the LBS 102 to register the application 306 with the LBS 102.

Additionally or alternatively, in some location-based applications the registrar component 308 can register/tag certain points of interest with the LBS 102. These points of interest may be fixed geographic locations or dynamic geographic locations. Pursuant to an example, the application 306 may be configured to notify certain contacts of the individual when the individual is approaching a hospital. In an example, a third party service can be employed to maintain a database of certain points of interests, such as hospitals, parks, restaurants, etc. A user or application may identify one or more of such points of interest in the database, and the LBS 102 can access such database to service requests from applications. Additionally or alternatively, the user can update the database by indicating certain locations that are specific to the user, such as a home of the user, a preferred grocery store, a school of the user, etc. Moreover, points of interest may be provided by an application, and the LBS 102 can access the database when servicing requests from applications. Further, as described above, the registrar component 308 can identify dynamically changing points of interest with the LBS 102. In an example, the application 306 may be configured to add points of interest after the user has registered the application 306 with the LBS.

The application 306 may also comprise an authentication data transmitter component 310 that is configured to transmit authentication data to the LBS 102 when the application is initiated on the computing device 300 or upon request from the LBS 102. This authentication data may be in the form of a public/private key pair that is known between the computing device 300 and the LBS 102. In another example, authentication data transmitted to the LBS 102 by the authentication data transmitter component 310 may be some form of data that uniquely identifies the application 306 executing on the computing device 300. This can allow the LBS 102 to determine the identity of the application and access certain operating restrictions provided by the user with respect to the application 306. Additionally, shared secrets can be utilized to provide encryption of a communication channel between the computing device 300 and one or more computing devices that include the LBS 102.

The application 306 also includes a request transmitter component 312 that can transmit requests for location information to the LBS 102. A request for location information generated by the request transmitter component 312 may be a request for location information with a particular level of accuracy, wherein such accuracy is utilized to provide content or a service to the user. In another example, the LBS 102 may be configured to push location information to the application 306 as such location information is received at the LBS 102, or the LBS 102 may be configured to push location information to the application 306 periodically according to application operating parameters. In some instances the location information at the LBS 102 may be stale. Accordingly, the request transmitter component 312 can generate a request that indicates to the LBS 102 that updated location information is desired by the application 306. In yet another example, the request transmitter component 312 can request that the LBS 102 initiate communication with the user. This communication may be in the form of a text message, email, etc. When the user responds to such request (or does not respond to such request), the LBS 102 can provide data pertaining to the response to the application 306 that generated the request.

In addition to generating requests for location information, the request transmitter component 312 can specify additional parameters. For example, the request transmitter component 312 may specify a time interval at which location updates are desired. Further, the request transmitter component 312 can specify that the LBS 102 provide location information when a location changes by a predetermined amount. Still further, the request transmitter component 312 can request that the LBS 102 perform or initiate a particular procedure when a location update cannot be received within a threshold amount of time (e.g., when the user is nearing a location of interest and devices registered by the user to output location information are unable to obtain sufficiently accurate location information, the request transmitter component 312 can request that the LBS 102 solicit a response from the user). The request transmitter component 312 can transmit requests to the LBS 102 by some commonly defined protocol. In this case, the computing device 300 may be a cloud computing device, a personal computing device, a mobile computing device, or other suitable computing device.

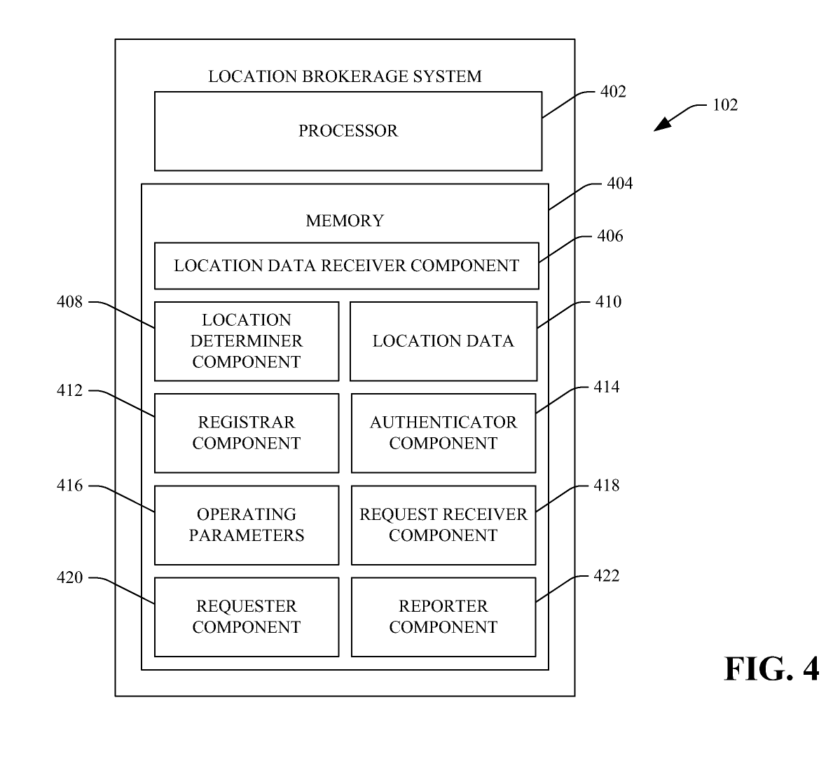

With reference now to FIG. 4, an exemplary detailed depiction of the LBS 102 is illustrated. The LBS 102 may be comprised by a cloud computing apparatus, a personal computing device, or distributed across numerous computing devices. The LBS 102 comprises at least one processor 402. The LBS 102 also comprises a memory 404 that comprises a plurality of components that are executable by the processor 402.

These components can include a location data receiver data component 406 that is configured to receive location data output by one or more sensor devices that are registered with the LBS 102. For example, some of such devices may be configured to periodically, or from time to time, automatically transmit location information to the LBS 102. In such instances, the location data receiver component 406 can passively receive the location information from such devices by way of some suitable communications channel or channels. Furthermore, the location data receiver component 406 can be configured to receive location information in a particular format and/or over a predefined protocol. If sensor devices communicate location information to the location data receiver component 406 in different formats, the location data receiver component 406 can be configured to automatically format the location information in particular format that is processible by the LBS 102. Location information received by the location data receiver component 406 can at least temporarily be retained in the memory 404 or some other suitable repository for subsequent processing.

The memory 404 also includes a location determiner component 408 that can compute or estimate a current location of the user based at least in part upon location information received by the location data receiver component 406. A location determined by the location determiner component 408 can be stored as location data 410 in the memory 404, or in some other data repository in the LBS 102 or accessible by the LBS 102. Further, the location determined by the location determiner component 408 can be purged after a certain amount of time such that locations of the user are not traceable over time. Moreover, the location determiner component 408 can be configured to determine location of the user at specified accuracy levels, and can initiate requests for location information from particular sensor devices to compute the location of the user at the particular accuracy level. Still further, the location determiner component 408 can leverage third party computations to translate raw data into latitude/longitude information.

The memory 404 also comprises a registrar component 412 that is configured to register one or more sensor devices and/or one or more applications with the LBS 102. As indicated above, a user can assign various operating parameters/restrictions to an application and/or sensor device during the registration process. In a certain example, a user may authorize one or more applications to subscribe to some or all of the location information pertaining to a user at a particular accuracy level. For instance, the registrar component 412 can provide a graphical user interface to the user such that the user can identify an application and grant the application rights to the location of the user. In one embodiment, the application may have a set of locations of interest that are registered with the LBS 102 when the user grants the application rights to the location of the user. Such locations of interest may be static (e.g., no locations of interest are added or removed unless the user again approves a change as proposed by the application) or dynamic (e.g., by granting the application access to the user's location information, the user has authorized the application to update its locations of interest without further user intervention). This type of registration can be undertaken through utilization of the registrar component 412.

When the application wishes to receive or request data from the LBS 102, the application can authenticate to the LBS 102. An authenticator component 414 in the memory 404 can receive data that can identify the application that desires to receive location information pertaining to the user. The authenticator component 414 can authenticate the application based at least in part upon the data provided by the application. During the authentication process, the authenticator component 414 can determine privileges of the application specified by the user as well as restrictions of utilization of the location data 410 specified by the user, and also evaluate signed (e.g., by a suitable digital signature scheme) data packets that provide some proof of certain privileges of the application. During the authentication process, the authenticator component 414 can identify one or more operating parameters 416 of the application requesting access to the location data 410. These operating parameters 416 can include level of accuracy requested by the application, amongst other operating parameters 416 described herein.

Generally, once an application has authenticated to the LBS 102, the LBS 102 can be configured to report the location data 410 to the application while considering the operating parameters 416 pertaining to such application. In such a scenario, the LBS 102 can be charged with obtaining data from the sensor devices and providing the location data 410 to the application in accordance with operating parameters of the application prescribed by the user. In some instances, however, it may be desirable to allow the application to request certain location data or location data at an increased level of accuracy. Still further, multiple applications may wish to have access to the location data 410, wherein such applications have different privileges with respect to the location data 410 and different levels of desired accuracy of the location data 410. In such cases, the LBS 102 can act as a clearing house and the enforcer of requests made by applications for the location data 410.

In a particular example, an application, once granted rights to the location data 410, may be authorized to make requests for greater location accuracy when the user enters one or more areas of interest. The LBS 102 can comprise a request receiver component 418 that can receive such requests from the application. In an example, the application may be configured to generate a notification to a plurality of contacts of the individual when the individual/user becomes proximate to a particular geographic location. When the user subscribes to a point of interest with the LBS 102, the user may implicitly or expressly grant rights for the application to specify points of interest and accuracy parameters for the points of interest (e.g., 100 meters, user verification, etc.). The LBS 102 can be used in this context as a clearinghouse for the collaborative process of analyzing requests for location information from application and obtaining appropriate location data from the sensor devices, and can further act as an enforcer of the requests made by the application for the location data 410. Specifically, there are two degrees of collaboration in this example: a first degree, between the LBS 102 and the devices that are capable of identifying the location of a user; and a second degree of collaboration, between the LBS 102 and authorized applications to satisfy requests or needs of the applications.

As indicated, the applications can generate a request that is received by the request receiver component 418. Additionally, the application is capable of using an appropriate API to communicate with the LBS 102 to dynamically qualify submitted requests or request particular actions to be taken in order to satisfy the business model of the application. The LBS 102 can receive such requests for qualifications through the request receiver component 418, and can evaluate and translate such requests expressed in terms of abstract primitive location operations.

The LBS 102 can include a requester component 420 that can act to request location data from one or more sensor devices. As described above, this can be done through a centralized process or through device-specific agents in determining which sensor devices to request location information from. Further, the requester component 420 can request location data from sensor devices to obtain a certain level of accuracy with respect to the location of a user and/or to satisfy a request received from an application.

A reporter component 422 can report back the location data 410 to the applications requesting certain data upon the LBS 102 receiving the desired location information from the sensor devices and the location determiner component 408 computing the location and causing such location to be stored in the location data 410. Thus, in summary, the LBS 102 can be configured to receive and process requests for location data from one or more applications, and can then act to obtain location information from one or more sensor devices to satisfy these requests in accordance with restrictions put in place by the user.

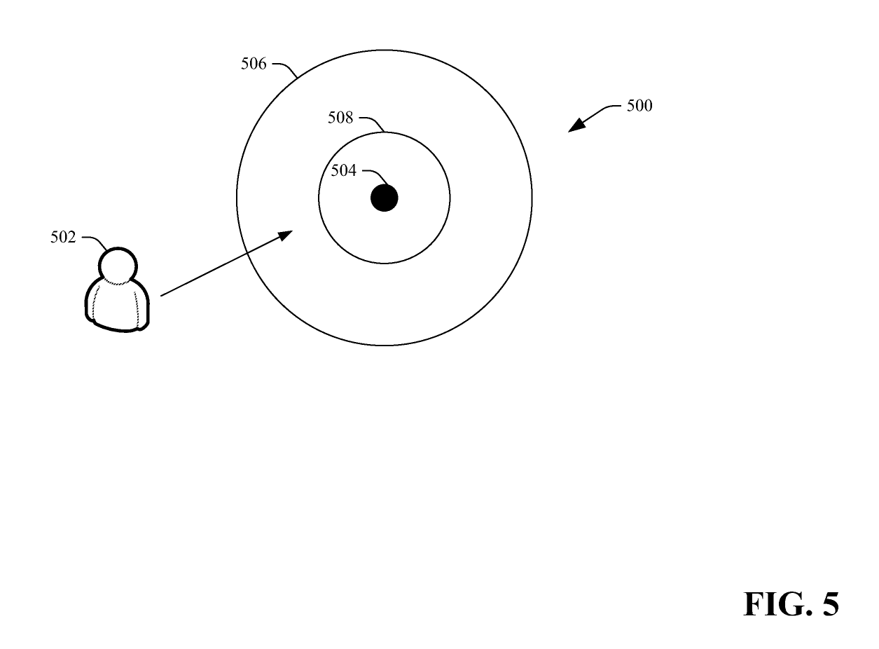

Turning now to FIG. 5, an exemplary illustration 500 of a user moving proximate to a point of interest is illustrated. In this example, a user 502 may be travelling in a particular geographic region. An application employed by the user may allow the user 502 to register a point of interest 504 with the LBS 102. The application can be configured, for example, to generate a notification to contacts of the user 502 when the user 502 becomes sufficiently proximate to the point of interest 504.

When the user is relatively far away from the point of interest 504, the application does not need incredibly precise location information. Therefore, the application can request location data from the LBS 102, or be provided with location data from the LBS 102, at a relatively low accuracy level. As the user 502 enters a region 506 that is closer to the point of interest 504, the application can submit a request to the LBS 102 to provide location data with a higher level of accuracy to the application. Additionally or alternatively, the LBS 102 can proactively monitor the user current location and request better accuracy to reduce chatter with the application and to satisfy an earlier request of the application. The LBS 102 may then collaborate with one or more sensor devices to obtain location information with the level of accuracy requested by the application (assuming that the application is authorized to receive location information with that level of accuracy).

As the user 502 travels still closer to the point of interest 504 within a second region 508, the application may request still further refined location data from the LBS 102. Again, the LBS 102 can obtain location information from sensor devices to service the request of the application.

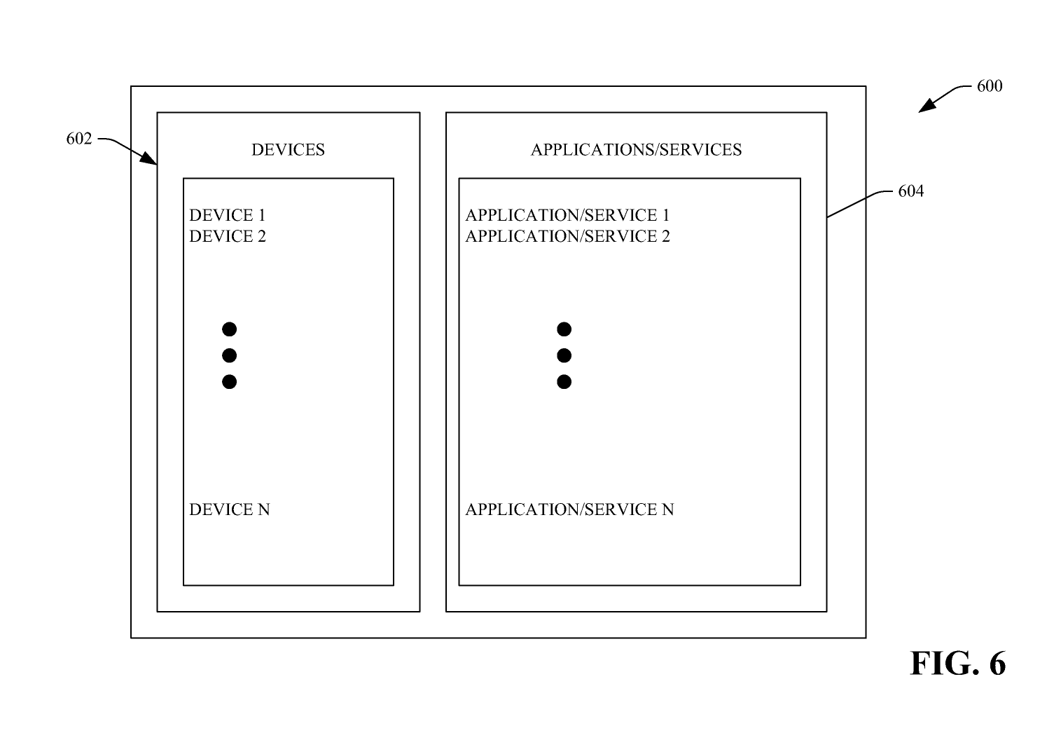

Referring now to FIG. 6, an exemplary graphical user interface 600 that can be utilized to identify operating parameters for location-based applications desirably executed on a computing device owned/operated by a user is illustrated. The graphical user interface 600 can be accessed, for instance, by directing a web browser to a particular web page that corresponds to the LBS 102. In this example graphical user interface 600, a first field 602 is presented that comprises a list of devices and/or sensors that can provide location information pertaining to a user, and a second field 604 that comprises a list of applications/services that are desirably utilized by the user. For example, the user can select one of the devices listed in the first field 602, and then may indicate which applications are authorized to receive data from the selected device. The process can additionally work in the reverse, wherein the user selects an application listed in the second field 604, and thereafter indicates which devices listed in the first field 602 can provide location information that is to be utilized by the selected application.

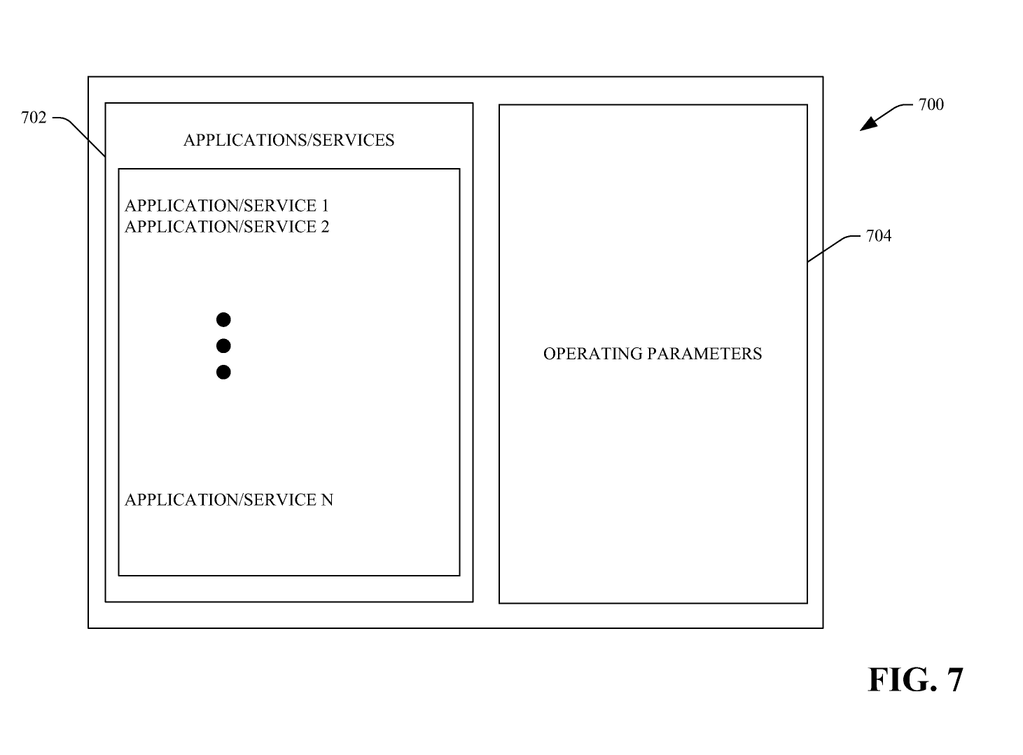

With reference now to FIG. 7, an exemplary graphical user interface 700 that allows the user to impose operating parameters with respect to one or more location-based applications that are utilized by the user is illustrated. The graphical user interface 700 comprises a first field 702 that includes a list of applications/services that are utilized or desirably utilized by the user. The graphical user interface 700 also comprises second field 704 that includes a list of operating parameters that can be applied to the applications. Thus, for instance, a user can select an application from the first field 704, and then may restrict operation of the applications through selection of one or more operating parameters in the second field 706. The second field 706 can include sliders, radio buttons, links, etc., to allow the user to impose operating parameters on one or more of the applications listed in the first field 704.

While these graphical user interfaces 600 and 700 have been described as being web-based in nature, it is to be understood that other graphical user interfaces that allow the user to define operating parameters with respect to one or more sensor devices and/or one or more applications are contemplated and are intended to fall under the scope of the hereto-appended claims. For example, a wizard can be employed to walk the user through configuration of sensors, applications, and/or the LBS 102.

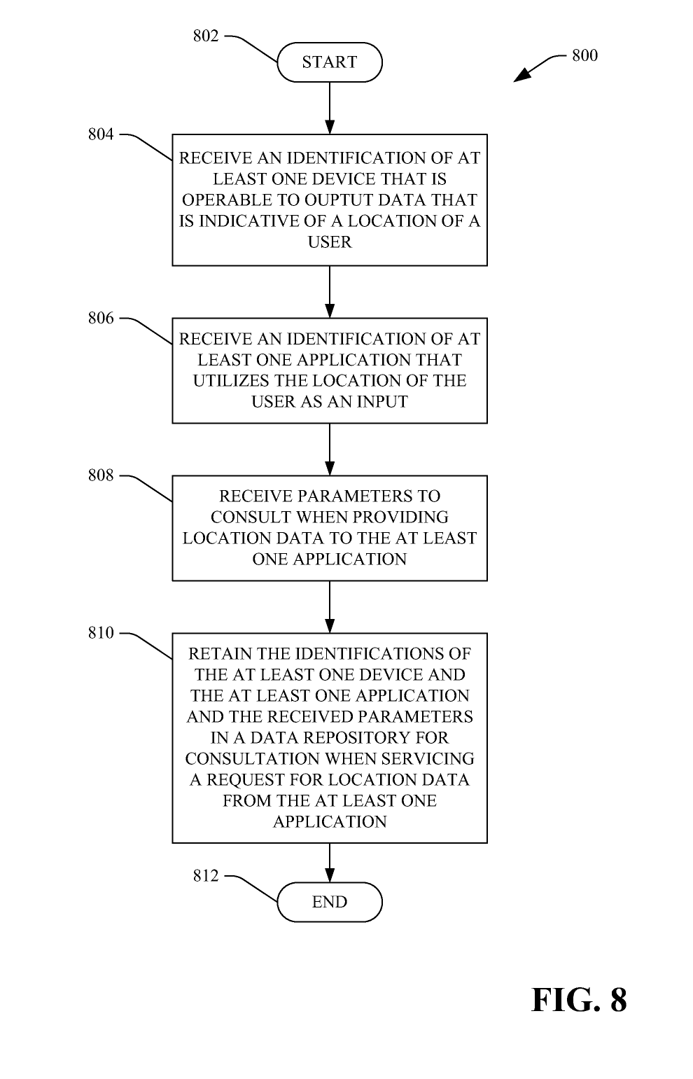

With reference now to FIGS. 8-10, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. The computer-readable medium may be a non-transitory medium, such as memory, hard drive, CD, DVD, flash drive, or the like.

Referring now to FIG. 8, an exemplary methodology 800 that facilitates registering a location-based application with a location brokerage system is illustrated. In an example, the methodology 800 may be executed in a cloud as part of a cloud computing service, on a personal computing device of a user, and/or in a dedicated virtual machine owned by the user. The methodology 800 starts at 802, and at 804 an identification of at least one device that is operable to output data that is indicative of location of a user is received. This identification can be explicitly provided by a user or automatically discovered.

At 806, an identification of at least one application that utilizes the location of the user as an input is received. Again, this identification can be received upon a user selection or can be automatically discovered based upon analysis of programs installed on a computing device.

At 808, operating parameters to consult when providing location data to the at least one application are received. For instance, the user can restrict provision of data to the application to location data with certain levels of accuracy, can restrict provision of location data to the application to certain times, etc.

At 810, the identifications of the at least one device and the at least one application and the received parameters are retained in a data repository for consultation when servicing a request for location data from the at least one application. This method 800 may be executed on a cloud computing device, for instance, by a LBS such as has been described above. The methodology 800 completes at 812.

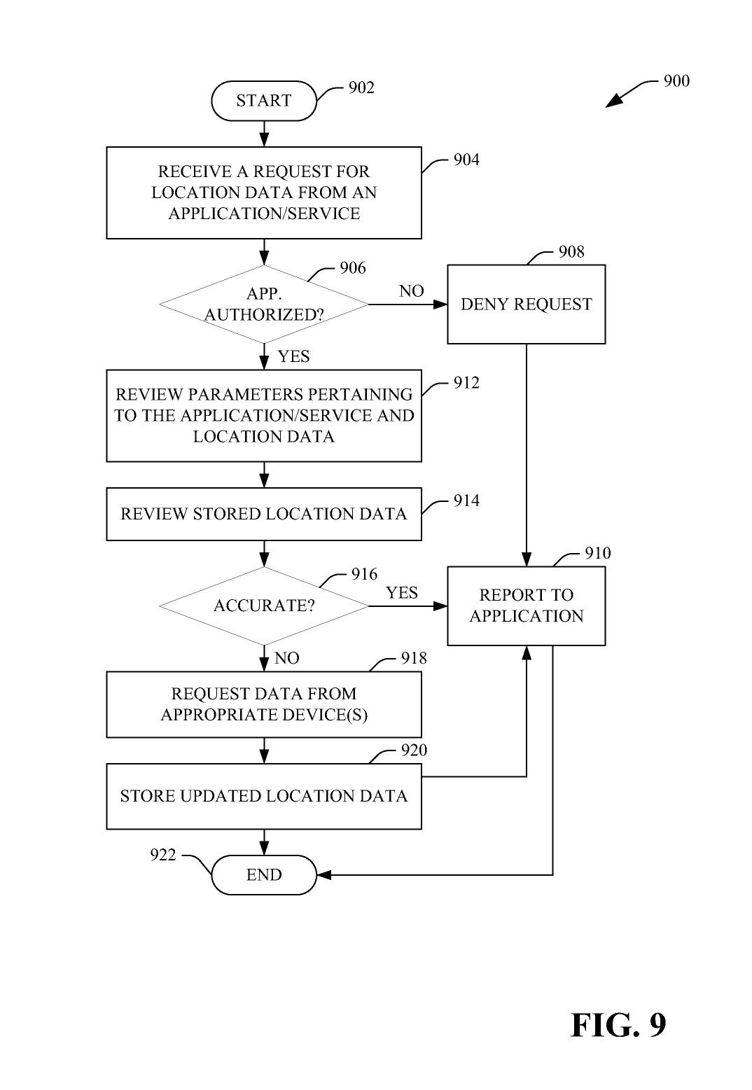

Referring now to FIG. 9, an exemplary methodology 900 that facilitates reporting to an application is illustrated. The methodology 900 starts at 902, and at 904 a request for location data is received from a location-based application/service. At 906, a determination is made regarding whether or not the application is authorized to receive the requested data. If the application is not authorized, then at 908 the request is denied, and at 910 the denied request is reported to the application.

If at 906 it is determined that the application is authorized to make such a request, at 912 operating parameters pertaining to the application/service and the location data are reviewed. These parameters can include a level of accuracy desired by the application, amongst other parameters.

Thereafter at 914, stored location data is reviewed. For example, the LBS can receive location information from a plurality of devices, and can compute the location of the user at some level of accuracy.

At 916, a determination is made regarding whether the stored data is sufficiently accurate. If the stored data is sufficiently accurate, then the methodology proceeds to 910, where the location data is reported to the application. If it is determined at 916 that the stored location data is not sufficiently accurate, then the methodology 900 proceeds to act 918, where a request for updated location data from appropriate sensor devices that are configured to output location information pertaining to the user is generated. The sensor devices may then respond to the request with updated location data. Once the data has been received from the sensor devices, at 920 the updated location data is stored, and the methodology proceeds to 910, where the updated location data is reported to the application requesting such data. The methodology 900 completes at 922.

The methodology 900 can be executed on a computing device that houses the LBS. This methodology 900 illustrates the collaborative nature of the LBS. First, the LBS can receive a request for data from an application, and can ascertain whether or not the current location data is sufficient to meet the request. If the current location data stored on the LBS is not sufficient to satisfy the request of the application, then the LBS can collaborate with one or more sensor devices to obtain the information desired by the application requesting the data.

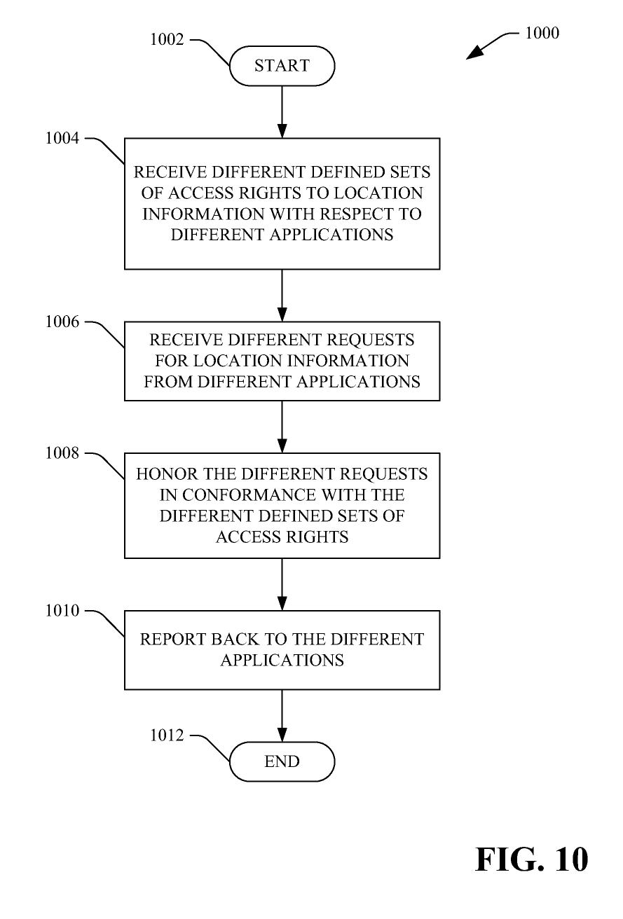

Referring now to FIG. 10, an exemplary methodology 1000 that facilitates providing location data to different applications with different operating parameters corresponding thereto is illustrated. The methodology 1000 begins at 1002, and at 1004 different defined sets of access rights to location information with respect to different applications are received. Thus, a first application can have a first set of access rights while a second application has a second set of access rights. The first set of access rights may restrict location information to a first level of accuracy, while the second set of access rights may allow an application to request location data with a second level of accuracy.

At 1006, different requests for location information are received from the different applications. These requests can be implicitly generated by the applications being executed on a computing device of the user. Alternatively, the applications can explicitly request location data when desired.

At 1008, the different requests from the different applications are honored in conformance with the different defined sets of access rights. Thus, each application can receive location data in conformance with the access rights corresponding to the applications. At 1010 appropriate location data is reported back to the different applications. In a situation where the level of accuracy of the location data is beyond the accuracy that is approved for an application, data can be obfuscated to ensure that accuracy restrictions are properly enforced. The methodology completes at 1012.

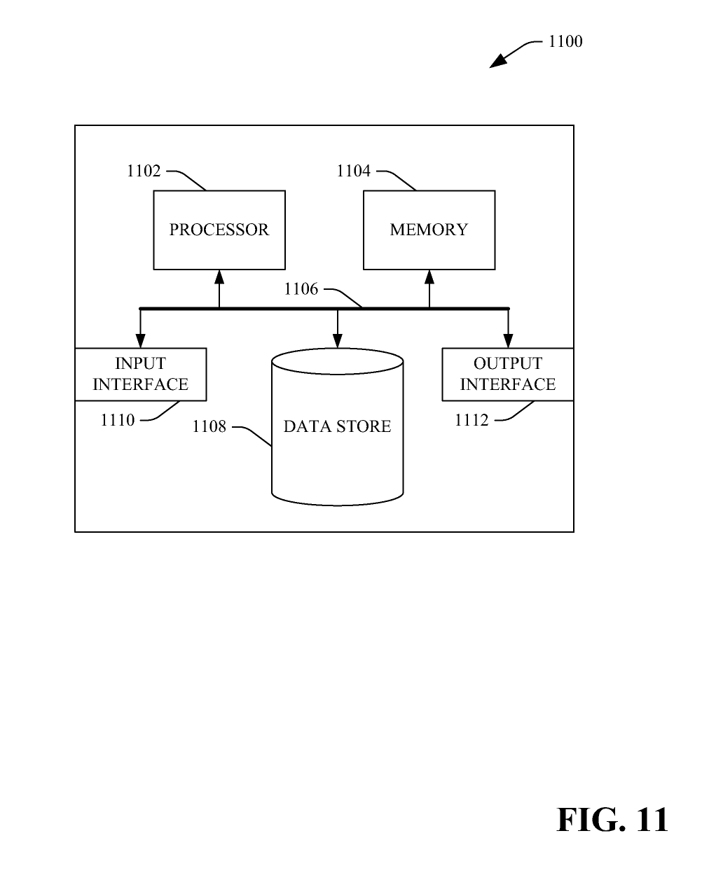

Now referring to FIG. 11, a high-level illustration of an exemplary computing device 1100 that can be used in accordance with the systems and methodologies disclosed herein is illustrated. For instance, the computing device 1100 may be used in a system that supports servicing location requests from location-based applications/services. In another example, at least a portion of the computing device 1100 may be used in a system that supports registering one or more applications or sensor devices with a LBS. The computing device 1100 includes at least one processor 1102 that executes instructions that are stored in a memory 1104. The memory 1104 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 1102 may access the memory 1104 by way of a system bus 1106. In addition to storing executable instructions, the memory 1104 may also store location data, restrictions on particular levels of accuracy to be provided to applications, etc.

The computing device 1100 additionally includes a data store 1108 that is accessible by the processor 1102 by way of the system bus 1106. The data store may be or include any suitable computer-readable storage, including a hard disk, memory, etc. The data store 1108 may include executable instructions, location data, identities of applications that are authorized to receive location data from a location brokerage system, etc. The computing device 1100 also includes an input interface 1110 that allows external devices to communicate with the computing device 1100. For instance, the input interface 1110 may be used to receive instructions from an external computer device, from a user, etc. The computing device 1100 also includes an output interface 1112 that interfaces the computing device 1100 with one or more external devices. For example, the computing device 1100 may display text, images, etc. by way of the output interface 1112.

Additionally, while illustrated as a single system, it is to be understood that the computing device 1100 may be a distributed system. Thus, for instance, several devices may be in communication by way of a network connection and may collectively perform tasks described as being performed by the computing device 1100.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices. Furthermore, a component or system may refer to a portion of memory and/or a series of transistors.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method comprising the following computer-executable acts:
receiving, at a computing apparatus, a plurality of data packets from a corresponding plurality of sensor devices, wherein each of the data packets comprises data that is indicative of a geographic location of a user;
receiving, at the computing apparatus, a first request for the geographic location of the user from a first computer-executable application, wherein the first request for the geographic location of the user has a first specified location accuracy;
processing one or more of the plurality of data packets to compute:
a location value that is indicative of the geographic location of the user; and
an accuracy value that is indicative of accuracy of the location value with respect to the geographic location of the user; and
providing the first computer-executable application with the location value if the accuracy value corresponds to the specified location accuracy specified by the first computer-executable application.

2. The method of claim 1, further comprising:
determining that the accuracy value is insufficient;
identifying at least one sensor device that is configured to output location data that, upon receipt, will cause the accuracy value to meet the specified location accuracy; and
requesting the location data from the at least one sensor device.

3. The method of claim 1, further comprising:
determining that the accuracy value is insufficient;
identifying at least one particular sensor device that is configured to output location data that, upon receipt, will cause the accuracy value to meet the specified location accuracy;
transmitting data to the at least one sensor device that causes the at least one sensor device to become active; and
receiving the location data from the at least one sensor device.

4. The method of claim 1 configured for execution on a cloud computing apparatus.

5. The method of claim 1 configured for execution on a personal computing device of the user or a dedicated virtual machine.

6. The method of claim 1, further comprising:
determining that the location value indicates that the user is within a predefined range of a point of interest registered by the user by way of the first computer-executable application;
determining that the application is authorized to receive location data at a greater accuracy level when the user is within the predefined range of the point of interest; and
providing the first computer-executable application with location data at the greater accuracy level.

7. The method of claim 1, further comprising:
receiving a second request for the geographic location of the user from a second computer-executable application, wherein the second request has a second specified location accuracy; and
providing location data to the second computer-executable application that conforms to the second specified location accuracy.

8. The method of claim 1, further comprising:
ascertaining that the location value is stale; and
transmitting a request to at least one sensor device to obtain more recent location data pertaining to the user.

9. The method of claim 1, further comprising:
causing an electronic message to be transmitted to a computing device of the user to solicit information from the user pertaining to a current geographic location of the user.

10. The method of claim 1, further comprising:
prior to receiving the request from the first-computer-executable application, receiving user input that authorizes the first computer-executable application to request location data and describes accuracy of location data that the application is authorized to request.

11. The method of claim 10, wherein the user input is received by way of a web page.

12. The method of claim 1, further comprising:
estimating an amount of battery life of a computing apparatus that comprises one of the sensor devices; and
determining whether to request location data from the one of the sensor devices based at least in part upon the estimated amount of battery life.

13. A computing apparatus comprising:
a processor; and
a memory that comprises components that are executable by the processor, the components comprising:
a request receiver component that receives a request from a computer-executable application for a location of a user, wherein the request has an indication of accuracy that is to correspond to the location of the user;
a requester component that causes a request for location data to be issued by way of a network connection to at least one sensor device, wherein the at least one sensor device is configured to output location data that is indicative of the location of the user, wherein the at least one sensor is selected based at least in part upon the indication of accuracy; and
a reporter component that reports the location of the user to the computer-executable application in conformance with the indication of accuracy that corresponds to the request.

14. The computing apparatus of claim 13, further comprising:
a location determiner component that processes data from a plurality of different sensor devices to ascertain the location of the user.

15. The computing apparatus of claim 14, wherein the location determiner component processes the data from the plurality of different sensor devices differently when different applications request the location of the user.

16. The computing apparatus of claim 13, wherein the request generated by the requester component is configured to cause the at least one sensor device to become active upon receipt thereof.

17. The computing apparatus of claim 13, further comprising:
a registrar component that receives registration data from the user regarding the computer-executable application and registers the computer-executable application with the computing apparatus, wherein the registration data comprises restrictions as to data that is requested by the computer-executable application, and wherein the requester component generates the request in conformance with the restrictions.

18. The computing apparatus of claim 17, wherein the registrar component is configured to generate a web page that is configured to receive the registration data from the user.

19. The computing apparatus of claim 13, wherein the requester component is configured to generate requests for transmittal to multiple sensor devices, and wherein the reporter component is configured to report different data packets to different applications requesting the location of the user, wherein the different data packets have different accuracy levels with respect to the location of the user.

20. A computer-readable medium comprising instructions that, when executed by a processor, cause the processor to perform acts comprising:
receiving requests for a geographic location of a user from a plurality of computer-executable applications;
analyzing operating parameters/restrictions for receiving the geographic location of the user with respect to the plurality of computer-executable applications, wherein the operating parameters/restrictions indicate that different computer-executable applications have different access rights with respect to receiving data that is indicative of the geographic location of the user;
based at least in part upon the operating parameters/restrictions, selectively requesting location data from at least one sensor device, wherein the location data is indicative of the geographic location of the user; and
providing location data to each of the plurality of computer-executable applications while conforming to the operating parameters/restrictions.
